(19) United States
(12) Patent Application Publication
(10) Pub. No.: US 2024/0409146 A1
(43) Pub. Date: Dec. 12, 2024

(54) Convertible Car Seat and Stroller Device

(71) Applicants: Maria Bazan, Braselton, GA (US); Daniil Bazan, Braselton, GA (US)

(72) Inventors: Maria Bazan, Braselton, GA (US); Daniil Bazan, Braselton, GA (US)

(21) Appl. No.: 18/503,297

(22) Filed: Nov. 7, 2023

Related U.S. Application Data
(60) Provisional application No. 63/507,547, filed on Jun. 12, 2023.

(51) Int. Cl. B62B 7/12

(52) U.S. Cl. CPC B62B 7/12; B62B 2205/123

(57) ABSTRACT

A convertible car seat device is disclosed that can be transformed from a car seat to a stroller. The device comprises a seat disposed within a frame, a pair of front wheels, a pair of rear wheels, a supporting member, a pivoting handle, and a wheel supporting member disposed in a bottom of the frame. The handle, the rear wheels, and the front wheels are foldable to use the device as a conventional car seat device inside a vehicle and are extendable to use the device as a stroller. The front wheels are folded and secured along a bottom portion of the sides of the frame and the rear wheels are folded and secured along a top portion of the sides of the frame. The device saves space in the vehicle by obviating the need to travel with separate car seat and stroller.

### CROSS-REFERENCE TO RELATED APPLICATION

The present application claims priority to, and the benefit of, U.S. Provisional Application No. 63/507,547, which was filed on Jun. 12, 2023, and is incorporated herein by reference in its entirety.

### FIELD OF THE INVENTION

The present invention generally relates to the field of child car seat devices and strollers. More specifically, the present invention relates to a novel convertible car seat device that can be converted into a stroller for carrying a child outside a vehicle. The car seat device is placed on a car seat base and is in a folded state to resemble a conventional car seat device when used inside a vehicle for a child. The handle, the front wheels, and the rear wheels are unfolded and extended to convert the car seat into a stroller. The device can be placed rear-facing or front-facing inside a vehicle and a sun-shade can be attached when used as a stroller. Accordingly, the present disclosure makes specific reference thereto. Nonetheless, it is to be appreciated that aspects of the present invention are also equally applicable to other like applications, devices, and methods of manufacture.

### BACKGROUND

By way of background, children are commonly seated in a convertible car seat in a vehicle during travelling. The convertible car seats are designed to accommodate children, can be adjusted, and can be used in both rear-facing and forward-facing positions, depending on the size and age of the child. Rear-facing positions are typically used for younger infants and toddlers, while forward-facing positions are suitable for older children. However, conventional convertible car seats are intended for use inside vehicles and are not meant to be used outside of the vehicle as a replacement for other child-carrying devices.

When traveling with a child, such as outside of the vehicle, a stroller is commonly used for carrying the child. A stroller is a wheeled device designed for transporting children, allowing parents to easily move them from one location to another. As a result, for travelling, vacations and more, parents are required to purchase both a convertible car seat and a stroller. Acquiring both a convertible car seat and a stroller can be expensive and additionally, carrying both of these items in the vehicle can occupy a significant amount of space in the vehicle. Also, during a journey, parents need to transfer the child from the car seat to the stroller when the child falls asleep which can cause disturbance leading to the child becoming cranky or irritable, which may cause inconvenience for both the child and the parents. Parents desire an improved convertible car seat that can also be used as a stroller for carrying a child outside the vehicle.

Therefore, there exists a long felt need in the art for a convertible car seat that can transition from a car seat to a stroller. There is also a long felt need in the art for an improved convertible car seat that can be used for carrying a child outside the vehicle. Additionally, there is a long felt need in the art for a novel convertible car seat that eliminates the requirement of purchasing a separate car seat and stroller for a child. Moreover, there is a long felt need in the art for a convertible car seat that can be used both as a conventional child car seat and a stroller. Further, there is a long felt need in the art for a convertible car seat that can transition into a stroller with the child positioned in the car seat. There is also a long felt need for parents that travel abroad on airplanes to have the convenience of the combination of a car seat and stroller in a single device, thereby eliminating excessive carrying at the airport. Finally, there is a long felt need in the art for an improved convertible car seat that offers convenience for parents, as well as saves space in the vehicle by obviating the need of a separate car seat and stroller.

The subject matter disclosed and claimed herein, in one embodiment thereof, comprises a convertible car seat configured to transition between a child car seat for in-vehicle use and a stroller for using outside the vehicle. The convertible car seat comprising a frame accommodating a seat, a belt coupled to the seat for securing a child, a handle, a pair of rear wheels, each rear wheel is supported by a rear wheel leg, a pair of front wheels, each front wheel is supported by a front wheel leg, a wheel supporting member disposed on the bottom surface of the frame and have supporting members connected to each front wheel leg and each rear wheel leg. The handle is in a retracted position, the rear wheels and the front wheels are in folded position when the convertible car is used in-vehicle as a child car seat and is positioned on a car seat base. The handle, the rear wheels and the front wheels are in extended position when the car seat is transformed into a stroller for carrying a child. The wheels are accommodated on sides of the frame when folded and the car seat is placed on and secured to a car seat base placed on a seat of a vehicle in either front-facing or rear-facing direction.

In this manner, the convertible car seat and stroller device of the present invention accomplishes all of the forgoing objectives and provides users with an improved convertible car seat that can transition into a stroller for use for carrying a child outside the vehicle. The car seat is placed inside a car for use as a conventional car seat and can be detached and unfolded to become a stroller.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a convertible car seat configured to transition between a child car seat for in-vehicle use and a stroller for use outside of the vehicle. The convertible car seat comprising a frame accommodating a seat, a handle, a pair of rear wheels, each rear wheel is supported by a rear wheel leg, a pair of front wheels, each front wheel is support by a front wheel leg, a wheel supporting member disposed on the bottom surface of the frame and have supporting members connected to each front wheel leg and each rear wheel leg, wherein the handle has a retracted position and an extended position, wherein the rear wheels have a folded position and an extended position, wherein the front wheels have a folded position and an extended position; wherein the handle is in retracted position, the rear wheels and the front wheels are in folded position when the convertible car is used in-vehicle as a child car seat and is positioned on a car seat base; wherein the handle, the rear wheels and the front wheels are in extended position when the car seat is transformed into a stroller for carrying a child.

In yet another embodiment, a convertible car seat is disclosed. The convertible car seat includes a car seat that includes a frame, the frame accommodates a seat that has a back portion and a front portion, the frame has a first side and an opposite second side, a pair of front wheels and a pair of rear wheels. In a folded position when the car seat is used as a child seat inside a car, the pair of front wheels are in a folded position by folding the associated legs wherein the pair of front wheels are accommodated along the sides of the frame, a pair of rear wheels are in folded position by folding the associated legs wherein the pair of rear wheels are also accommodated along the sides of the frame, and the handle is in a retracted position. In the unfolded position, the pair of front wheels are extended by extending the associated legs and the pair of rear wheels are extended by extending the associated legs and the handle is extended to orient on top of the seat. In the unfolded position, the front wheels are positioned in front of the front portion of the seat and the rear wheels are positioned behind the back portion of the seat.

In yet another embodiment, a device that functions as a car seat for children and that can be converted into a stroller outside of the vehicle is disclosed. The device in a folded state functions like a standard convertible car seat that can be installed rearward facing or forward facing. During installation in a vehicle, the device is placed on a seat which secures the device. The rear wheels, the front wheels and the handle are in a folded position when the device is used as a standard convertible car seat. To transition the device into a stroller, the handle is extended, and the front wheels and the rear wheels are extended or unfolded to function as conventional stroller wheels wherein a sunshade is detachably attached to the frame of the device.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side elevation view of a convertible car seat of the present invention in accordance with the disclosed structure;

FIG. 2 illustrates a perspective view of a car seat base used for securing the convertible car seat inside a vehicle in accordance with the disclosed structure;

FIG. 3 illustrates a perspective view of the convertible car seat secured in the car seat base in accordance with the disclosed structure;

FIG. 4 illustrates a side elevation view of the convertible car seat in an unfolded orientation to convert into a stroller in accordance with the disclosed structure; and

FIG. 5 illustrates a side perspective view showing the convertible car seat transformed into the stroller position completely in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a convertible car seat that can transition into a stroller. There is also a long felt need in the art for an improved convertible car seat that can be used for carrying a child outside the vehicle. Additionally, there is a long felt need in the art for a novel convertible car seat that eliminates the requirement of purchasing separate car seat and stroller for a child. Moreover, there is a long felt need in the art for a convertible car seat that can be used both as a conventional child car seat and a stroller. Further, there is a long felt need in the art for a convertible car seat that can transition into a stroller with the child positioned in the car seat. There is also a long felt need for parents that travel abroad on airplanes to have the convenience of the combination of a car seat and stroller in a single device, thereby eliminating excessive carrying at the airport. Finally, there is a long felt need in the art for an improved convertible car seat that offers convenience for parents, as well as saves space in the vehicle by obviating the need of separate car seat and stroller.

The present invention, in one exemplary embodiment, is a convertible car seat device that functions as a car seat for children and can be converted into a stroller outside of the vehicle is disclosed. The device in a folded state functions like a standard convertible car seat that can be installed rear or forward facing. During installation in a vehicle, the device is placed on a seat which secures the device. The rear wheels, the front wheels and the handle are in a folded position when the device is used as a standard convertible car seat. To transition the device into a stroller, the handle is extended, and the front wheels and the rear wheels are extended or unfolded to function as conventional stroller wheels wherein a sunshade is detachably attached to the frame of the device. The front wheels are supported by a pivotable front wheel leg and the rear wheels are supported by a pivotable rear wheel leg.

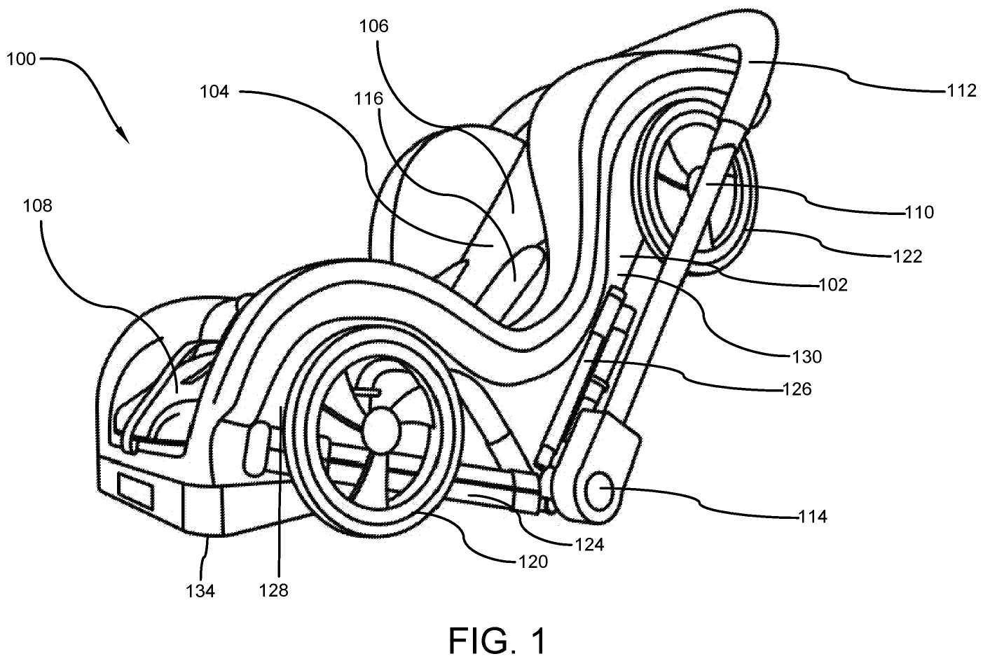

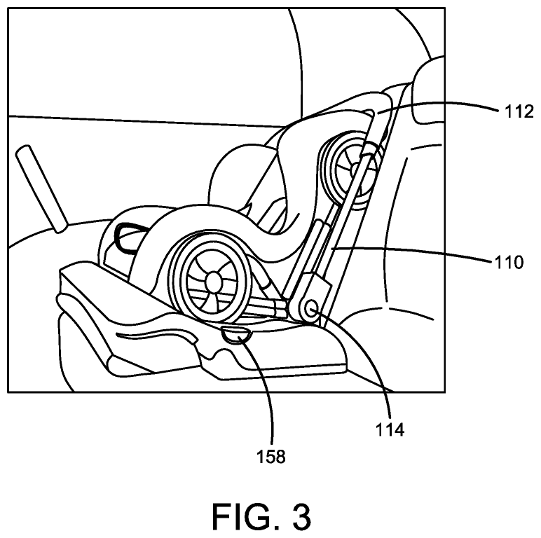

Referring initially to the drawings, FIG. 1 illustrates a side elevation view of a convertible car seat of the present invention in accordance with the disclosed structure. FIG. 1 shows only one side of the convertible car seat 100, however, most components include a complementary component on the opposite side of the convertible car seat 100 but are not shown in FIG. 1. The convertible car seat 100 is configured to have a transition between the car seat orientation as illustrated in FIG. 1 to a stroller orientation as illustrated in FIG. 3.

The convertible car seat 100 includes a seat frame 102 for supporting a seat 104. The seat 104 can be permanently affixed to the frame 102 or releasably connected, such that it is capable of being removed and substituted with a different seat. The seat 104 has a rearwardly inclined back portion 106 for supporting a back of a child sitting in the car seat 100 and has a front portion 108 for supporting the bottom and legs of the child.

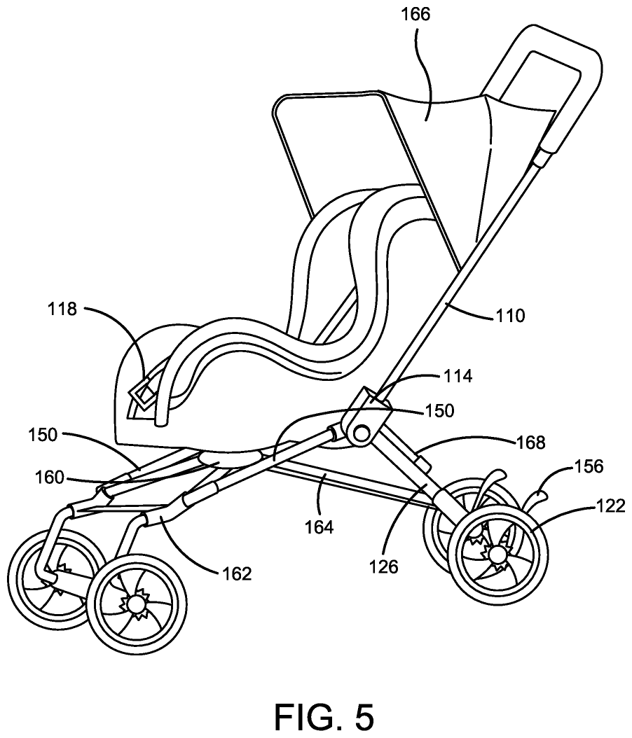

The convertible car seat 100 includes a pivotable handle 110 having a grip portion 112 and is positioned along the frame 102 to circumscribe the back portion 106 of the seat 104. The handle 110 is pivotable and includes the handle pivoting control 114 for pivoting the handle 110. For securing a child in the car seat 100, a seat belt 116 is provided which can be fastened using any conventional fastener such as a buckle 118 as illustrated in FIG. 5. The handle 110 is in a retracted position and is positioned along the top of the frame 102 when the device 100 is in a folded state to be used inside a vehicle as illustrated in FIGS. 1-3.

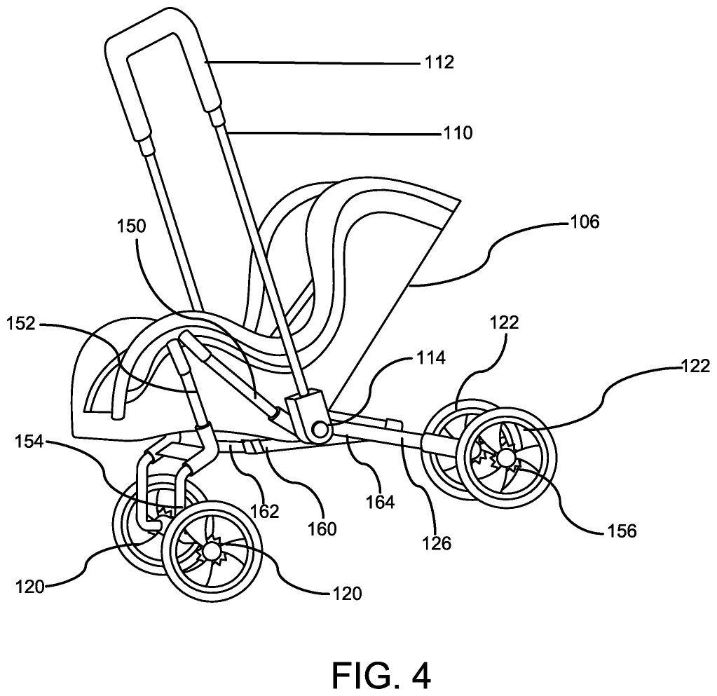

The combined stroller and car seat device 100 has a pair of front wheels 120 and a pair of rear wheels 122, the front wheels 120 have colinear left wheel and right wheel and the rear wheels 122 include colinear left wheel and right wheel. The front wheels 120 are attached to the frame 102 using front wheel leg 124, and the rear wheels 122 are attached to the frame 102 using rear wheel leg 126. In the car seat orientation as illustrated in FIG. 1, the front wheel leg 124 and the front wheels 120 are accommodated along the horizontal portion 128 of the frame 102. Similarly, the rear wheels 122 and the rear wheel leg 126 are accommodated along the inclined portion 130 of the frame 102. The legs 124, 126 can be extended to convert the car seat into a stroller as illustrated in FIG. 4.

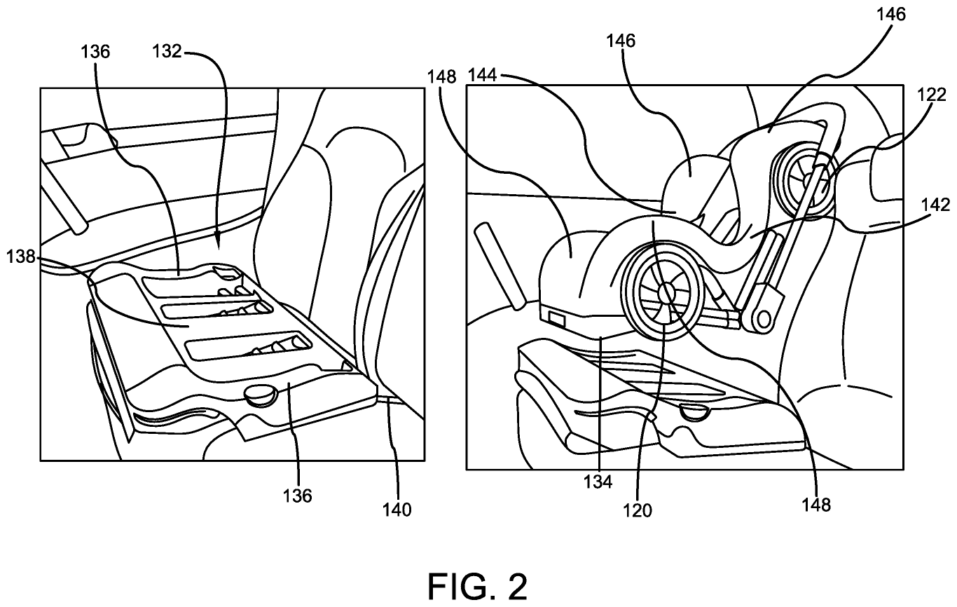

Referring to FIGS. 2 and 3, the convertible car seat 100 comes with a car seat base 132 used for securing the bottom portion 134 of the frame 102 to a vehicle's latch or belt system. The base 132 includes a pair of side grooves 136 for accommodating and securing the front wheels 120. The central portion 138 of the base 132 provides support to the car seat 100. The seat base 132 is secured to the belt system of the vehicle using harnesses or belts 140. The sides 142, 144 of the seat 104 are designed to have a first curved shape 146 for supporting and accommodating the rear wheels 122 and a second curved shape 148 for supporting and accommodating the front wheels 120. The push button 158 can be pushed to release the car seat device 100 from the base 132 for easy removal and accessibility. The base 132 can be made of any soft material and can be ergonomic for securing the convertible car seat 100 in both rear-facing and front-facing positions.

FIG. 4 illustrates a side elevation view of the convertible car seat in an unfolded orientation to convert into a stroller in accordance with the disclosed structure. For converting the car seat 100 into a stroller, the car seat device 100 is removed from the base 132. The handle 110 is pivotally moved to position on top of the seat 102 wherein the handle 110 can be extended to be positioned in an extended position. Then, rear wheel legs 126 are unfolded by pulling the rear wheels 122 behind the back portion 106. Each front leg 124 has a first pivoting member 150 and a second pivoting member 152 which rests above each other when front wheel 120 is folded as illustrated in FIG. 1 and pivotally extends on pulling and unfolding the front wheel 120. The second pivoting member 152 has an integrally connected arcuate member 154 which is connected to the front wheel 120. The rear wheels 122 have wheel locks 156 for restricting movement thereof and can be pulled to apply the lock or brakes.

A wheels supporting member 160 is disposed on the bottom portion 134 of the frame 102. The wheels supporting member 160 is flexible and can be stitched to the bottom portion 134 of the frame 102. The wheels supporting member 160 is coupled to the front legs 124 and the rear legs 126 using the connecting members 162, 164 respectively.

FIG. 5 illustrates a side perspective view showing the convertible car seat transformed into the stroller position completely in accordance with the disclosed structure. In the fully unfolded or extended position, the convertible car seat 100 can be used as a stroller as illustrated in the present embodiment. A sun shade 166 can be detachably attached to the frame 102 for protecting the child sitting in the seat 104 from sunlight and other weather elements. The handle 110 is in the fully extended position and can be used for maneuvering the stroller. The wheel locks 156 can be used for locking the motion of the stroller and in the stroller orientation, the rear wheel legs 126 of the rear wheels 122 are completely extended and are further supported by the supporting member 168 that extends across the opposite sides of the frame 102.

In the instance of an older child that is heavier, the convertible car seat 100 presents the option of pulling a child out of the car seat, and then pulling out the car seat out of the car and unfolding it to transition into a stroller. Further, the convertible car seat 100 enables older toddlers, when sitting in the stroller position, to have attachable and detachable leg rests to be moved around and locked in position to accommodate length of child's legs.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “convertible car seat”, “car seat”, “combined stroller and car seat device”, “car seat device”, and “device” are interchangeable and refer to the combined stroller and car seat device 100 of the present invention.

Notwithstanding the forgoing, the combined stroller and car seat device 100 of the present invention can be of any suitable size and configuration as is known in the art without affecting the overall concept of the invention, provided that it accomplishes the above stated objectives. One of ordinary skill in the art will appreciate that the combined stroller and car seat device 100 as shown in the FIGS. 1-5 are for illustrative purposes only, and that many other sizes and shapes of the combined stroller and car seat device 100 are well within the scope of the present disclosure. Although the dimensions of the combined stroller and car seat device 100 are important design parameters for user convenience, the combined stroller and car seat device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A convertible car seat configured to transition between a car seat and a stroller, the convertible car seat comprising:
a seat frame for supporting a car seat, a seat belt, a handle, and a plurality of wheels;
wherein said car seat having a rearwardly inclined back portion for supporting a back of a child sitting in said car seat and a front portion for supporting the bottom and the legs of the child;
wherein said handle is selectively rotatable and selectively retractable for using said convertible car seat as said car seat; and
further wherein said handle is selectively rotatable and selectively extendable for using said convertible car seat as said stroller.

2. The convertible car seat of claim 1, wherein said pivotable handle having a grip portion positioned along said car seat frame and circumscribing said back portion.

3. The convertible car seat of claim 2, wherein said plurality of wheels having a pair of front wheels and a pair of rear wheels.

4. The convertible car seat of claim 3, wherein said pair of front wheels having colinear left wheel and right wheel, and further wherein said pair of front wheels connected to said car seat frame with a front wheel leg.

5. The convertible car seat of claim 4, wherein said pair of rear wheels having colinear left wheel and right wheel, and further wherein said pair of rear wheels connected to said car seat frame with a rear wheel leg.

6. The convertible car seat of claim 5, wherein said front wheel leg and said rear wheel leg selectively retractable for using said convertible car seat as said car seat.

7. The convertible car seat of claim 6, wherein said front wheel leg and said rear wheel leg selectively extendable for using said convertible car seat as a stroller.

8. The convertible car seat of claim 7, wherein said rear wheel leg proximal to said rearwardly inclined back portion of said car seat.

9. The convertible car seat of claim 8, wherein said front wheel leg proximal to said front portion of said car seat.

10. The convertible car seat of claim 9, wherein said car seat selectively removable from said car seat frame.

11. A convertible car seat configured to transition between a car seat and a stroller, the convertible car seat comprising:
a seat frame for supporting a car seat, a car seat base, a seat belt, a handle, and a plurality of wheels;
wherein said plurality of wheels having a pair of front wheels and a pair of rear wheels;
wherein said car seat having a rearwardly inclined back portion for supporting a back of a child sitting in said car seat and a front portion for supporting the bottom and the legs of the child;
wherein said handle is selectively rotatable and selectively retractable for using said convertible car seat as said car seat;
wherein said handle is selectively rotatable and selectively extendable for using said convertible car seat as said stroller;
wherein said car seat frame having a bottom portion for selectively securing to said car seat base; and
further wherein said car seat base having a pair of side grooves securing said pair of front wheels.

12. The convertible car seat of claim 11, wherein said car seat base selectively securable to a belt system of a vehicle.

13. The convertible car seat of claim 12, wherein said pair of front wheels having colinear left wheel and right wheel, wherein said pair of front wheels connected to said car seat frame with a front wheel leg, wherein said pair of rear wheels having colinear left wheel and right wheel, and further wherein said pair of rear wheels connected to said car seat frame with a rear wheel leg.

14. The convertible car seat of claim 13, wherein said front wheel leg and said rear wheel leg selectively retractable for using said convertible car seat as said car seat.

15. The convertible car seat of claim 14, wherein said front wheel leg and said rear wheel leg selectively extendable for using said convertible car seat as a stroller.

16. A method of converting a child seat between a car seat and a stroller, the method comprising the steps of:
providing a convertible car seat having a seat frame for supporting a car seat, a car seat base, a seat belt, a handle, and a plurality of wheels, wherein said car seat having a rearwardly inclined back portion for supporting a back of a child sitting in said car seat and a front portion for supporting the bottom and the legs of the child;
rotating and retracting said handle for using said convertible car seat as said car seat;
securing a bottom portion of said car seat frame to said car seat base;
securing said pair of front wheels to a pair of side grooves of said car seat base;
using said convertible car seat as said car seat;
removing said car seat from said car seat base; and
rotating and extending said handle for using said convertible car seat as said stroller.

17. The method of converting a child seat between a car seat and a stroller of claim 16, wherein said car seat base selectively securable to a belt system of a vehicle.

18. The method of converting a child seat between a car seat and a stroller of claim 17, wherein said plurality of wheels having a pair of front wheels including a front wheel leg, and a pair of rear wheels including a rear wheel leg.

19. The method of converting a child seat between a car seat and a stroller of claim 18, wherein said front wheel leg and said rear wheel leg selectively retractable for using said convertible car seat as said car seat.

20. The method of converting a child seat between a car seat and a stroller of claim 19, wherein said front wheel leg and said rear wheel leg selectively extendable for using said convertible car seat as a stroller.
